(19) United States
(12) Patent Application Publication
(10) Pub. No.: US 2011/0076975 A1
(43) Pub. Date: Mar. 31, 2011

(54) METHOD AND APPARATUS FOR WIRELESS LOCATION MEASUREMENT

(75) Inventors: Kanghee KIM, Daejeon (KR); Jisoo Park, Daejeon (KR)

(73) Assignee: Electronics and Telecommunications Research Institute, Daejeon (KR)

(21) Appl. No.: 12/892,385

(22) Filed: Sep. 28, 2010

(30) Foreign Application Priority Data
Sep. 28, 2009 (KR) 10-2009-0091638
Sep. 13, 2010 (KR) 10-2010-0089623

(51) Int. Cl. H04B 17/00

(52) U.S. Cl. 455/226.1

(57) ABSTRACT

A wireless location measurement method of a receiver includes: receiving signals from a transmitter for a plurality of time intervals; extracting a final propagation delay tab profile based on a plurality of signals that are received for the plurality of time intervals; and calculating a distance between the transmitter and the receiver by using the final propagation tab delay profile. A wireless location measurement apparatus includes: a receiver for receiving signals from a transmitter for a plurality of time intervals; an accumulator for accumulating the plurality of signals and outputting an accumulated signal; a propagation delay tab extractor for extracting a propagation delay tab profile of the accumulated signal; and a location measurer for measuring a location by using the propagation delay tab profile.

### CROSS-REFERENCE TO RELATED APPLICATION

This application claims priority to and the benefit of Korean Patent Application No. 10-2009-0091638 and 10-2010-0089623 filed in the Korean Intellectual Property Office on Sep. 28, 2009 and Sep. 13, 2010, the entire contents of which are incorporated herein by reference.

### BACKGROUND OF THE INVENTION

(a) Field of the Invention

The present invention relates to a wireless location measurement method and apparatus.

(b) Description of the Related Art

Wireless location measurement includes acquiring information on location, speed, or features of things by using wireless communication.

Wireless location measurement methods include the angle of arrival (AOA) method, the received signal strength indicator (RSSI) method, the time of arrival (TOA) method, the time difference of arrival (TDOA) method, and the delay spread of arrival (DSOA) method. The TOA method, the TDOA method, and the DSOA method from among the wireless location measurement methods measure locations by using characteristics of wireless channels.

The location measurement method using the characteristic of the wireless channel estimates the wireless channel by using received signals, and calculates a distance based on the estimated wireless channel. In this instance, the wireless channel can be estimated in the propagation delay tab profile. However, in the propagation delay tab profile, a signal transmitted by a transmitter is spread in the temporal axis while passing through the wireless channel to have distribution of delay tabs, and an arrival time of a first delay tab or a peak delay tab with the greatest signal intensity, signal strength, or delay spread can be changed depending on the receiving time. Therefore, accuracy of location measurement can be reduced when the location is measured by using the propagation delay tab profile that is variable with respect to time.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a wireless location measurement method and apparatus for increasing accuracy of location measurement on a time-variant wireless channel.

An exemplary embodiment of the present invention provides a wireless location measurement method of a receiver, including receiving signals from a transmitter for a plurality of time intervals; extracting a final propagation delay tab profile based on a plurality of signals that are received for the plurality of time intervals, and calculating a distance between the transmitter and the receiver by using the final propagation tab delay profile.

The extracting of a propagation delay tab profile includes accumulating the plurality of signals, and extracting the final propagation delay tab profile based on the accumulated signals.

The accumulating of a plurality of signals includes accumulating the plurality of signals by applying a weight value to the plurality of signals.

The accumulating of a plurality of signals further includes extracting a plurality of propagation delay tab profiles corresponding to the plurality of signals, determining reliability of the plurality of propagation delay tab profiles, and calculating the weight value based on the reliability.

The determining of reliability includes determining the reliability by using a distribution of the propagation delay tabs in the plurality of propagation delay tab profiles.

The accumulating of a plurality of signals further includes receiving weight value information from the transmitter, and calculating the weight value by using the weight value information.

The extracting of a propagation delay tab profile includes extracting a plurality of propagation delay tab profiles corresponding to the plurality of signals, and determining the final propagation delay tab profile by accumulating the plurality of propagation delay tab profiles.

The determining of a final propagation delay tab profile includes applying a weight value to the plurality of propagation delay tab profiles, and accumulating the plurality of propagation delay tab profiles.

The determining of a final propagation delay tab profile further includes determining reliability of the plurality of propagation delay tab profiles, and calculating the weight value based on the reliability.

The determining of reliability includes determining the reliability by using a distribution of the propagation delay tabs in the plurality of propagation delay tab profiles.

The determining of a final propagation delay tab profile further includes receiving weight value information from the transmitter, and calculating the weight value by using the weight value information.

Another embodiment of the present invention provides a wireless location measurement apparatus including: a receiver for receiving signals from a transmitter for a plurality of time intervals; an accumulator for accumulating the plurality of signals and outputting an accumulated signal; a propagation delay tab extractor for extracting a propagation delay tab profile of the accumulated signals; and a location measurer for measuring a location by using the propagation delay tab profile.

The accumulator accumulates the plurality of signals by applying a weight value to the plurality of signals.

The wireless location measurement apparatus further includes a controller for calculating the weight value of the plurality of signals based on reliability of propagation delay tab profiles corresponding to the plurality of signals.

The wireless location measurement apparatus further includes a controller for calculating the weight value based on weight value information provided by the transmitter.

Yet another embodiment of the present invention provides a wireless location measurement apparatus including: a propagation delay tab extractor for extracting a plurality of propagation delay tab profiles corresponding to a plurality of signals that are received for the plurality of time intervals; an accumulator for determining a final propagation delay tab profile by accumulating the plurality of propagation delay tab profiles; and a location measurer for measuring a location by using the final propagation delay tab profile.

The accumulator accumulates the plurality of propagation delay tab profiles by applying a weight value to the plurality of propagation delay tab profiles.

The wireless location measurement apparatus further includes a controller for calculating the weight value of the plurality of propagation delay tab profiles based on reliability of the plurality of propagation delay tab profiles.

The wireless location measurement apparatus further includes a controller for calculating the weight value based on weight value information provided by the transmitter.

According to an embodiment of the present invention, the accuracy of location measurement can be increased when the wireless channel is changed with respect to time.

### BRIEF DESCRIPTION OF THE DRAWINGS

FIG. 1 shows a wireless location measurement system according to an exemplary embodiment of the present invention.

FIG. 2A to FIG. 2C show propagation delay tab profiles according to an exemplary embodiment of the present invention.

FIG. 3 shows a wireless location measurement apparatus according to an exemplary embodiment of the present invention.

FIG. 4 shows a flowchart of a wireless location measurement method of a wireless location measurement apparatus according to an exemplary embodiment of the present invention.

FIG. 5 shows a wireless location measurement apparatus according to another exemplary embodiment of the present invention.

FIG. 6 shows a flowchart of a wireless location measurement method of a wireless location measurement apparatus according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

A wireless location measurement method and apparatus according to exemplary embodiments of the present invention will now be described with reference to drawings.

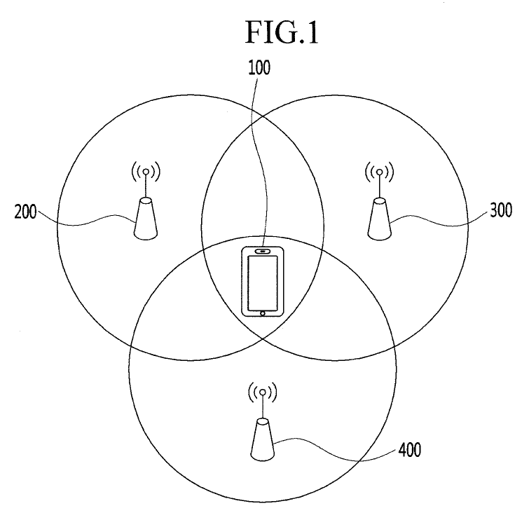

FIG. 1 shows a wireless location measurement system according to an exemplary embodiment of the present invention.

Referring to FIG. 1, the wireless location measurement system includes a receiver 100 and a plurality of transmitters (200-400). The transmitters (200-400) transmit signals to a wireless channel, and the receiver 100 includes a wireless location measurement apparatus for receiving the signals and measuring a location. The receiver 100 receives the signals from the transmitters (200-400) to calculate distances from the transmitters (200-400), and estimates the location of the receiver 100 by using the calculated distances and an algorithm such as the least squares method based on triangulation.

The distances between the receiver 100 and the respective transmitters (200-400) are calculated by using the characteristics of the wireless channel. For this, the receiver 100 uses the received signals to extract a propagation delay tab profile including a delay tab, and uses the propagation delay tab profile to find the distance.

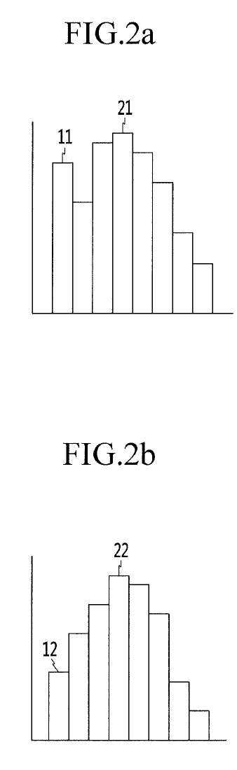

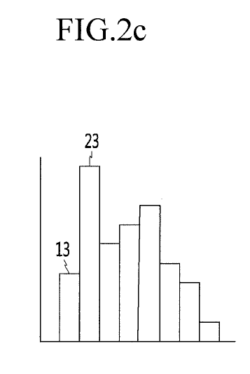

FIG. 2A to FIG. 2C show a propagation delay tab profile according to an exemplary embodiment of the present invention.

Referring to FIG. 2A, the horizontal axis of the propagation delay tab profile represents a time of arrival of the radio waves signifying a delay time of the radio waves, and the vertical axis indicates strength of the signal. The receiver 100 can know a delay time of delay tabs including a first delay tab 11 and a peak delay tab 21 with the greatest signal intensity through the propagation delay tab profile, and can also find a delay spread value representing a delay spread degree. Since the delay time or delay spread value found through the propagation delay tab profile is in proportion to the distance, the distance between the transmitter and the receiver can be found by using the same.

Referring to FIG. 2A to FIG. 2C, when the receiver 100 extracts the propagation delay tab profile on the same location, different propagation delay tab profiles can be extracted with respect to time. For example, the propagation delay tab profile extracted by the receiver 100 can have different intensities of the signal of the first delay tabs 11-13 according to the time when the signals are received, and the time of arrival of the peak delay tabs 21-23 can be different, and so the accuracy of location measurement can be influenced by the time when the signal is received. A method and apparatus for increasing accuracy of location measurement when the location is measured by using the time-variant propagation delay tab profile will now be described.

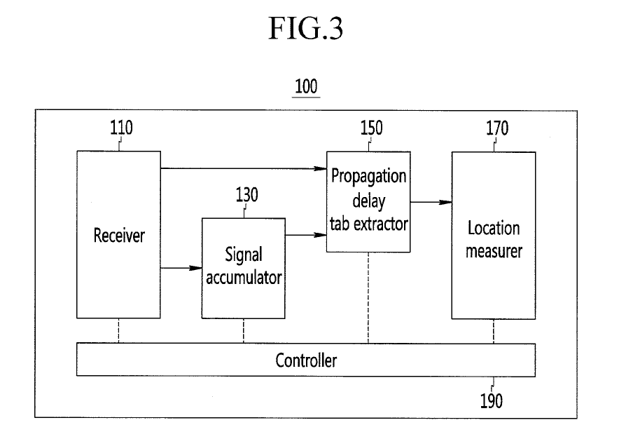

FIG. 3 shows a wireless location measurement apparatus according to an exemplary embodiment of the present invention.

Referring to FIG. 3, a wireless location measurement apparatus of the receiver 100 includes a receiver 110, a signal accumulator 130, a propagation delay tab extractor 150, a location measurer 170, and a controller 190.

The receiver 110 receives signals from the transmitter (e.g., 200 of FIG. 1) for a plurality of time intervals. For example, in the case of receiving the signals for three time intervals, the receiver 110 receives signals in the first time interval, receives signals in the second time interval after a predetermined time, and receives signals in the third time interval after a predetermined time.

The signal accumulator 130 accumulates an output signal of the receiver 110 according to a statistical calculation method, such as adding the input signals or adding the input signals with weight values.

The propagation delay tab extractor 150 extracts a propagation delay tab profile corresponding to the input signal. The input signal can be an output signal of the receiver 110 or the signal accumulator 130. When receiving the output signal from the receiver 110, the propagation delay tab extractor 150 can extract a propagation delay tab profile corresponding to a plurality of signals, and when receiving the output signal from the signal accumulator 130, it can extract a final propagation delay tab profile.

The location measurer 170 measures a location by using a final propagation delay tab profile. The location measurement method using the propagation delay tab profile can be variable, and for example, the location can be measured by using a delay time of a first delay tab, a delay time of a peak delay tab, or a delay spread value, and the location can be measured by using a delay tab showing signal strength that is greater than a threshold value.

The controller 190 controls the receiver 110, the signal accumulator 130, the propagation delay tab extractor 150, and the location measurer 170.

The controller 190 controls the receiver 110 to set a plurality of time intervals, and setting information of the time intervals includes a length of the time intervals, a gap of the time intervals, and a number of time intervals for receiving the signals.

The controller 190 sets information on the weight value of the signal accumulator 130. The controller 190 controls the signal accumulator 130 regarding whether to apply the weight value and accumulate the signals, and sets the weight value when accumulating the signals by applying the weight value. The controller 130 calculates reliability of the propagation delay tab profiles by using the propagation delay tab profile corresponding to a plurality of signals, and determines the weight value based on the reliability. In addition, the controller 190 receives information for setting the weight value from the transmitter 200, and sets the weight value by using the information. The information for setting the weight value includes traveling speed information of a terminal and wireless channel information.

The controller 190 controls information set to the propagation delay tab extractor 150. The controller 190 sets parameter information for extracting the propagation delay tab profile and controls an operational time of the propagation delay tab extractor 150.

The controller 190 controls information sent to the location measurer 170. The information depends on the location measurement method, and the method for using the time of arrival (TOA) sets a reference for selecting a delay tab for distance estimation, a threshold value for determining a valid state of a signal, and information that is corrected to increase accuracy of location measurement.

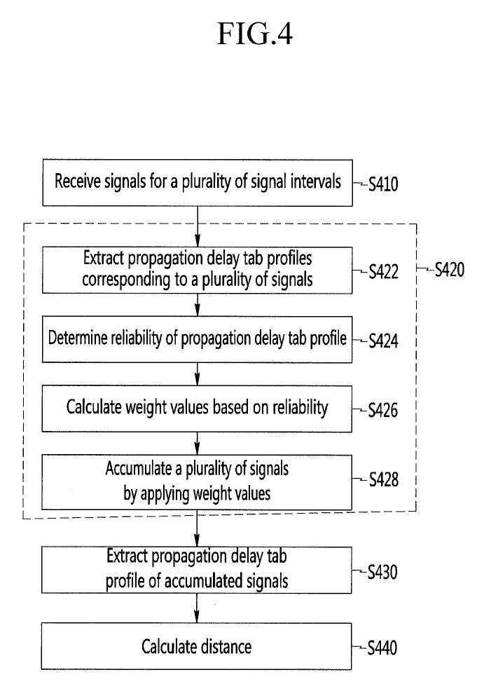

A receiver shown in FIG. 3 will now be described with reference to FIG. 4.

FIG. 4 shows a flowchart of a wireless location measurement method of a wireless location measurement apparatus according to an exemplary embodiment of the present invention.

Referring to FIG. 4, the receiver 100 receives signals from the transmitter (e.g., 200 of FIG. 1) for a plurality of time intervals (S410).

The receiver 100 accumulates a plurality of signals that are received for a plurality of time intervals (S420). To accumulate a plurality of signals, the receiver 100 extracts a propagation delay tab profile corresponding to the received plurality of signals (S422). The receiver 100 determines the reliability of the propagation delay tab profile corresponding to the received signals (S424), and calculates weight values of the received signals based on the reliability (S426). In this instance, the receiver 100 determines the reliability by using a distribution of the propagation delay tab in the propagation delay tab profile. Differing from this, the receiver 100 receives weight value information for setting the weight value from the transmitter 200, and calculates the weight value by using weight value information. For example, the weight value information includes traveling speed information of a terminal and wireless channel information. The receiver 100 accumulates a plurality of signals by applying a weight value to a plurality of signals that are received for a plurality of time intervals (S428).

The receiver 100 extracts a propagation delay tab profile based on the accumulated signals (S430).

The receiver 100 calculates a distance between the transmitter 200 and the receiver 100 by using the extracted propagation tab delay profile (S440). The receiver 100 additionally calculates distances from other transmitters (e.g., 300 and 400 of FIG. 1) to estimate the location of the receiver 100.

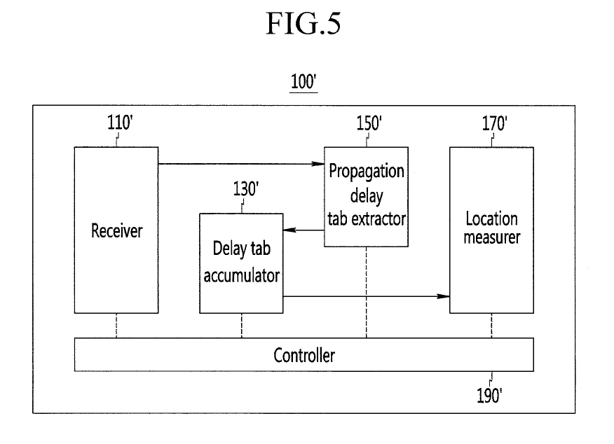

FIG. 5 shows a wireless location measurement apparatus according to another exemplary embodiment of the present invention.

Referring to FIG. 5, a wireless location measurement apparatus of the receiver 100′ includes a receiver 110′, a delay tab accumulator 130′, a propagation delay tab extractor 150′, a location measurer 170′, and a controller 190′.

The receiver 110′ receives signals from the transmitter (e.g., 200 of FIG. 1) for a plurality of time intervals.

The propagation delay tab extractor 150′ extracts a plurality of propagation delay tab profiles corresponding to a plurality of output signals of the receiver 110′.

The delay tab accumulator 130′ accumulates a plurality of propagation delay tab profiles to determine a final propagation delay tab profile. For example, the delay tab accumulator 130′ adds a plurality of propagation delay tab profiles, or applies weight values to a plurality of propagation delay tab profiles and adds them.

The location measurer 170′ measures the location by using the final propagation delay tab profile. The location measurement method using the propagation delay tab profiles is variable, and for example, the location can be measured by using a delay time of a first delay tab, a delay time of a peak delay tab, or a delay spread value, and the location can be measured by using a delay tab having signal strength that is greater than a threshold value.

The controller 190′ controls the receiver 110′, the delay tab accumulator 130′, the propagation delay tab extractor 150′, and the location measurer 170′. The controller 190′ sets a plurality of time intervals of the receiver 110′. Also, the controller 190′ controls weight value information including a weight value applied state of the delay tab accumulator 130′ and the weight value. In this instance, the controller 190′ determines the weight value based on the reliability of a plurality of propagation delay tab profiles, or determines the weight value by receiving information for setting the weight value such as traveling speed information of a terminal or wireless channel information from the transmitter 200. The controller 190′ sets parameter information for extracting the propagation delay tab profile, and controls information set to the propagation delay tab extractor 150′ such as an operational time of the propagation delay tab extractor 150′. The controller 190′ increases accuracy of location measurement by controlling information sent to the location measurer 170′.

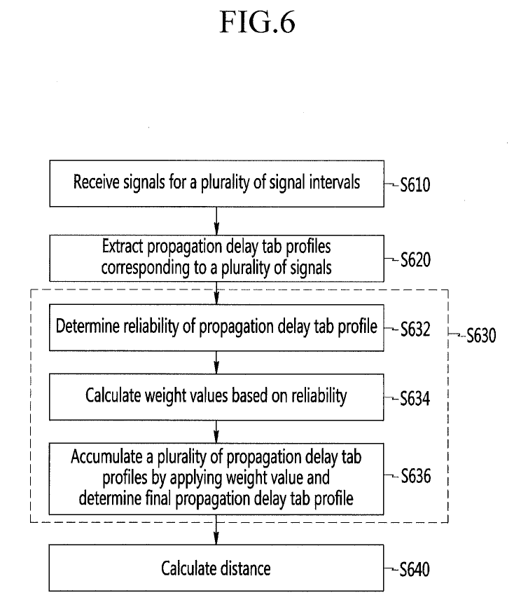

A receiver shown in FIG. 5 will now be described with reference to FIG. 6.

FIG. 6 shows a flowchart of a wireless location measurement method of a wireless location measurement apparatus according to another exemplary embodiment of the present invention.

Referring to FIG. 6, the receiver 100′ receives signals from the transmitter (e.g., 200 of FIG. 1) for a plurality of time intervals (S610).

The receiver 100′ extracts a plurality of propagation delay tab profiles corresponding to a plurality of signals that are received for a plurality of time intervals (S620).

The receiver 100′ accumulates a plurality of propagation delay tab profiles to determine a final propagation delay tab profile (S630). To determine the final propagation delay tab profile, the receiver 100′ determines the reliability of the propagation delay tab profiles corresponding to the received signals (S632), and calculates the weight value based on the reliability (S634). The reliability is determined by using the distribution of the propagation delay tab in the propagation delay tab profile. In this instance, the weight value is calculated by using information for setting the weight value provided by the transmitter 200, for example, traveling speed information of a terminal or wireless channel information. The receiver 100′ applies the weight value and accumulates a plurality of propagation delay tab profiles to determine the final propagation delay tab profile (S636).

The receiver 100′ calculates the distance between the transmitter 200 and the receiver 100′ by using the final propagation tab delay profile (S640). The receiver 100′ estimates the location of the receiver 100′ by additionally calculating the distance from other transmitters (e.g., 300 and 400 of FIG. 1).

When the receiver (100, 100′) uses the accumulator (130, 130′), the accuracy of location measurement is increased when the extracted propagation delay tab profile is changed with respect to time.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A wireless location measurement method of a receiver, comprising:
receiving signals from a transmitter for a plurality of time intervals;
extracting a final propagation delay tab profile based on a plurality of signals that are received for the plurality of time intervals; and
calculating a distance between the transmitter and the receiver by using the final propagation tab delay profile.

2. The wireless location measurement method of claim 1, wherein
the extracting of a propagation delay tab profile includes:
accumulating the plurality of signals; and
extracting the final propagation delay tab profile based on the accumulated signals.

3. The wireless location measurement method of claim 2, wherein
the accumulating of a plurality of signals includes accumulating the plurality of signals by applying a weight value to the plurality of signals.

4. The wireless location measurement method of claim 3, wherein
the accumulating of a plurality of signals further includes:
extracting a plurality of propagation delay tab profiles corresponding to the plurality of signals;
determining reliability of the plurality of propagation delay tab profiles; and
calculating the weight value based on the reliability.

5. The wireless location measurement method of claim 4, wherein
the determining of reliability includes
determining the reliability by using a distribution of the propagation delay tabs in the plurality of propagation delay tab profiles.

6. The wireless location measurement method of claim 3, wherein
the accumulating of a plurality of signals further includes:
receiving weight value information from the transmitter; and
calculating the weight value by using the weight value information.

7. The wireless location measurement method of claim 1, wherein
the extracting of a propagation delay tab profile includes:
extracting a plurality of propagation delay tab profiles corresponding to the plurality of signals; and
determining the final propagation delay tab profile by accumulating the plurality of propagation delay tab profiles.

8. The wireless location measurement method of claim 7, wherein
the determining of a final propagation delay tab profile includes applying a weight value to the plurality of propagation delay tab profiles, and accumulating the plurality of propagation delay tab profiles.

9. The wireless location measurement method of claim 8, wherein
the determining of a final propagation delay tab profile further includes:
determining reliability of the plurality of propagation delay tab profiles; and
calculating the weight value based on the reliability.

10. The wireless location measurement method of claim 9, wherein
the determining of reliability includes
determining the reliability by using a distribution of the propagation delay tabs in the plurality of propagation delay tab profiles.

11. The wireless location measurement method of claim 8, wherein
the determining of a final propagation delay tab profile further includes:
receiving weight value information from the transmitter; and
calculating the weight value by using the weight value information.

12. A wireless location measurement apparatus comprising:
a receiver for receiving signals from a transmitter for a plurality of time intervals;
an accumulator for accumulating the plurality of signals and outputting an accumulated signal;
a propagation delay tab extractor for extracting a propagation delay tab profile of the accumulated signal; and
a location measurer for measuring a location by using the propagation delay tab profile.

13. The wireless location measurement apparatus of claim 12, wherein
the accumulator accumulates the plurality of signals by applying a weight value to the plurality of signals.

14. The wireless location measurement apparatus of claim 13, further including
a controller for calculating the weight value of the plurality of signals based on reliability of propagation delay tab profiles corresponding to the plurality of signals.

15. The wireless location measurement apparatus of claim 13, further including
a controller for calculating the weight value based on weight value information provided by the transmitter.

16. A wireless location measurement apparatus comprising:
a receiver for receiving signals from a transmitter for a plurality of time intervals;
a propagation delay tab extractor for extracting a plurality of propagation delay tab profiles corresponding to a plurality of signals that are received for the plurality of time intervals;
an accumulator for determining a final propagation delay tab profile by accumulating the plurality of propagation delay tab profiles; and
a location measurer for measuring a location by using the final propagation delay tab profile.

17. The wireless location measurement apparatus of claim 16, wherein
the accumulator accumulates the plurality of propagation delay tab profiles by applying a weight value to the plurality of propagation delay tab profiles.

18. The wireless location measurement apparatus of claim 17, further including
a controller for calculating the weight value of the plurality of propagation delay tab profiles based on reliability of the plurality of propagation delay tab profiles.

19. The wireless location measurement apparatus of claim 17, further including
a controller for calculating the weight value based on weight value information provided by the transmitter.
